(19) United States
(12) Patent Application Publication
(10) Pub. No.: US 2025/0148680 A1
(43) Pub. Date: May 8, 2025

(54) Improved Avatar Creation

(71) Applicant: ORANGE, Issy-Les-Moulineaux (FR)

(72) Inventor: Guillaume Bataille, Chatillon (FR)

(21) Appl. No.: 18/836,942

(22) PCT Filed: Feb. 8, 2023
(86) PCT No.: PCT/EP2023/053050

§ 371 Date: Aug. 8, 2024

(30) Foreign Application Priority Data
Feb. 10, 2022 (FR) FR2201154

(51) Int. Cl. G06T 13/40

(52) U.S. Cl. CPC G06T 13/40

(57) ABSTRACT

A method for creating an avatar of a user. The method includes: obtaining at least image data of the user and processing the image data in order to determine morphological parameters specific to the user; and applying, to a parametric avatar model, the morphological parameters specific to the user in order to obtain a personalized parametric avatar of the user.

### CROSS-REFERENCE TO RELATED APPLICATIONS

This Application is a Section 371 National Stage Application of International Application No. PCT/EP2023/053050, filed Feb. 8, 2023, and published as WO 2023/152153 A1 on Aug. 17, 2023, not in English, which claims priority to French Patent Application No. 2201154, filed Feb. 10, 2022, the contents of which are hereby incorporated by reference in their entireties.

### FIELD OF THE DISCLOSURE

This description concerns the creation of an avatar of a natural person, based on attributes specific to that person.

### BACKGROUND OF THE DISCLOSURE

An avatar can serve to represent the natural person virtually in computer applications, for example messaging, or in online games, or more generally in a virtual environment or “metaverse”.

Current techniques for creating an avatar of a user of such applications rely on:
either a so-called “dense” reconstruction of the user's appearance via one or more cameras (for example color cameras of the “RGB” type) and/or an infrared depth camera, and doing so by using a physical device (A),
or the creation of a parametric avatar, which allows the user to configure the appearance of their avatar using predefined models, by clicking on dedicated icons (for example sliders) to choose their hairstyle, hair color, height, skin color, eye color, etc., and doing so by using a computer application (B).

However, dense reconstruction results in an avatar that is not customizable and requires a very large volume of data. For example, the hair color, eye color, skin color, etc. cannot be changed. Furthermore, an avatar that is too realistic is not always well received by users, who find their virtual representation upsetting because, although it is very close, it is not absolutely perfect (according to the “uncanny valley” theory initiated in particular by Masahiro Mori).

As for the creation of a parametric avatar, it is not realistic because it does not correspond to the user's actual body measurements and cannot faithfully reproduce their features, but it uses few resources and is therefore much more suitable for virtual telepresence applications. Parametric avatars do not take into account the user's actual traits. The user is offered predefined features typical of cartoon characters, to which the user adds personalized eye color, hair, glasses, beard, etc. The result remains “cartoonish” (in the sense of an appearance similar to a cartoon character), despite some attributes being chosen by the user.

### SUMMARY

The present invention improves this situation.

To this end, it proposes a method for creating an avatar of a user, comprising:
obtaining at least image data of the user and processing said data in order to determine morphological parameters specific to the user, and
applying, to a parametric avatar model, the morphological parameters specific to the user in order to obtain a personalized parametric avatar of the user.

By implementing the above method, it is thus possible to obtain a parametric avatar, therefore one that is modifiable by the user according to their own choices or needs; however, this initial avatar is realistic because it is personalized by means of the image data of the user. Indeed, the value of at least one parameter of the avatar is personalized according to at least one morphological parameter among the morphological parameters specific to the user that were determined based on the image data of the user obtained by the method for creating an avatar.

The aforementioned morphological parameters of the user may typically be the shape and arrangement in the face of elements such as the nose, eyes, mouth, etc., or the dimensions (relative or absolute) of limb segments such as forearms, legs, etc., or the color of the skin, hair, beard if any, etc.

They may be identified in the image data by making use of artificial intelligence and/or colorimetry and photogrammetry applications.

The method according to the invention thus makes it possible to create a personalized avatar more quickly because it does not require the complex and detailed parameterization utilized for the creation of an avatar by volumetric capture of the user. However, unlike the creation of a parametric avatar where only aesthetic parameters may be selected from a catalog, the method according to the invention proposes modifying morphological parameters of the avatar not by selecting values from a catalog but by using morphological parameters of the user, which makes it possible to create a personalized parametric avatar that is morphologically true to the user. The parametric avatar created by the method according to the invention is at least partially true morphologically to the user (height and/or waist circumference and/or hand dimension, etc.).

An advantage of such a personalized parametric avatar that is morphologically true to the user is that it allows the user to try products in the virtual world prior to a purchase, or even prior to their manufacture (furniture, car, clothing, house, apartment, etc.). Another advantage of a personalized parametric avatar that is morphologically true to the user is that it allows interaction with real objects in augmented reality while limiting interaction errors, since the avatar is true to the user's morphology.

One technical effect of this personalized parameterization of the avatar according to the morphological parameters of the user is that, since the avatar is parametric in character, this allows modifying the avatar at a later time so as to create one or more different versions.

For example, the image data may be acquired by a plurality of cameras in order to construct a stereoscopic 3D model of the user.

Additionally or alternatively, the image data may further be acquired by at least one infrared camera in order to acquire at least image depth data of the user and construct a 3D model of the user.

In one embodiment, the method may comprise:
determining, based on said image data, at least relative body measurements of the user by photogrammetry, and evaluating morphological parameters characteristic of the user.

These relative measurements may be for example the distance between the eyes relative to the width of the face, or the height of the nose relative to the total height of the face, or the width of the nose relative to the width of the face, or the length of the forearm relative to the total length of the arm, etc.

These measurements are relative, but it is possible to measure and configure parameters for absolute dimensions. For example, the image data may further comprise data from a test pattern of known dimension (for example in the field of images taken of the user), for determining absolute body measurements of the user.

The method may further comprise:
determining, by colorimetry and based on said image data, at least the skin color and/or hair color of the user.

Thus, the initially constructed realistic avatar may accurately reflect the color of the user's hair and/or skin and/or beard if any, etc.

In addition to or alternatively to the use of colorimetry and/or photogrammetry applications, the method may provide for making use of artificial intelligence to identify, based on said image data, different parts of the user's body and to configure parameters for said different parts of the body.

For example, the aforementioned artificial intelligence may determine a color, a length, etc. of these different parts of the body, associating them with an identifier (by a processing that “labels” the different parts of the body). This identifier is then recognized by an application for creating a parametric avatar, which receives this data.

In one embodiment, an application for creating a parametric avatar may be programmed to accept as input parameters at least the following:
shapes and dimensions of elements of the user's face,
colors of at least the user's skin and/or hair,
dimensions of segments of the user's limbs.

Examples of such an application for creating a parametric avatar are given below. The “Make Human Project” application is cited herein simply as a non-limiting example.

Due to the use of this user-specific parameterized data, the parametric avatar created is realistic. However, since it is parametric, it may be modified as desired by the user for example.

Thus, in one embodiment, the method may further comprise:
modifying the personalized parametric avatar of the user, at the user's request.

For example, the user may choose to change a hair color, an eye color, a skin color, a type of clothing, etc.

Additionally or alternatively, the method may further comprise, during the execution of an application in which the avatar takes part:
modifying the personalized parametric avatar of the user, upon receiving a command from the application.

In this embodiment, for example as the application continues to execute (for example an online game), the avatar may be modified automatically by the application (for example by making the avatar grow and widen as the user wins rounds in the game).

In one embodiment, in addition to the image data, voice data of the user is acquired in order to accompany a physical appearance of the personalized avatar of the user, with a realistic vocal expression of the user.

Thus, in such an implementation, the avatar created is faithful both in physical appearance and in the voice given to the avatar. However, as the avatar is parametric, the user may choose to give it a modified voice (for example deeper, etc.).

According to another aspect, a computer program is proposed comprising instructions for implementing the method as defined above when these instructions are executed by a processor of a processing circuit. According to another aspect, a non-transitory computer-readable storage medium is provided, on which such a program is stored.

According to another aspect, a computer device is proposed comprising a processing circuit configured to implement the method presented above.

### BRIEF DESCRIPTION OF THE DRAWINGS

Other features, details and advantages will become apparent upon reading the detailed description below, and upon analyzing the attached drawings, in which:

FIG. 1 illustrates the estimation of a parametric avatar that is as realistic as possible, based on a dense photorealistic model of a user,

FIG. 2 illustrates one possible embodiment consisting of the creation of multiple personalized avatars, based on the most realistic parametric avatar possible,

FIG. 3 illustrates an example of a device for implementing the above method.

### DETAILED DESCRIPTION OF ILLUSTRATIVE EMBODIMENTS

The object of the present invention makes it possible to create a user avatar by combining an application for creating a parametric avatar with a dense capture of the user's actual appearance.

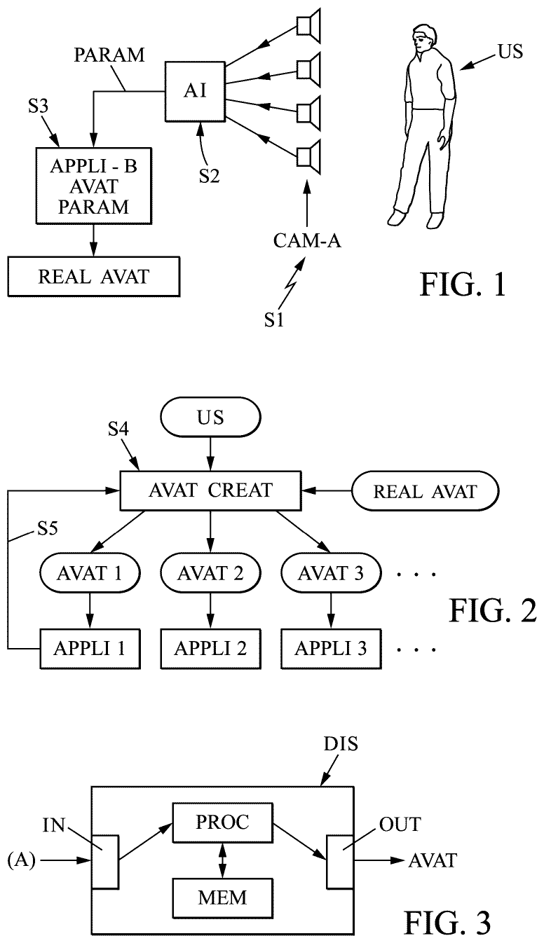

With reference to FIG. 1, in a first step S1, user US positions himself or herself in front of a device A for creating a dense avatar, for example one or more cameras CAM or an infrared depth camera.

Said cameras CAM may form a set of cameras referred to as a “rig” (with around fifty cameras for example) surrounding the user in a half-cylinder or cylinder in order to capture a 3D model of the user's entire body, by stereoscopy. Additionally or alternatively, said infrared depth camera may provide 3D information by projecting, for example, an infrared grid with detection of round trip times of the infrared rays at each point on the user's body. One such infrared camera model is known as the “Kinect”®.

In a second step S2, a computer processing circuit (of the type illustrated in FIG. 3 by way of example) is connected to device A to then create a “photorealistic avatar”: of the same size and having the same proportions as the user. “Photorealistic avatar” is understood here to mean a particularly realistic 3D model of the user, which at the minimum may consist of a set of data stored in memory, this data defining:
the color of the skin, eyes, hair, beard if any, eyebrows, etc.
the shape of the face: shape and height of the nose relative to the height of the face, shape and distance of the eyes relative to the width of the face, arrangement and shape of the mouth, arrangement and shape of the ears, shape of the chin, etc.
the shape of the limbs: relative length of the forearms compared to the arms, trunk, legs, etc.
posture: curvature of the back, pelvic tilt, etc.

Of course, the above data examples are not exhaustive. Furthermore, the dimensions of parts of the body may be given relative to another part of the body or may be absolute. In the second case, a test pattern of known dimensions may be placed with the user within the field of camera(s) CAM for carrying out the first image acquisition step S1.

For example, in step S2, artificial intelligence AI may be involved for:
identifying in the acquired images the skin color, hair color, etc., as well as the dimensions of parts of the body, and other elements,
configuring this identified information in the form of said stored data,
and providing this data PARAM to a parametric avatar model in the next step S3.

Indeed, step S3 consists of configuring the parameters for the creation of the user's avatar in the most realistic way possible, with a parametric application B based on the photorealistic avatar obtained in step S2. In step S3, the parameter data thus configured (for example by the aforementioned artificial intelligence) may then be provided to an application B for creating a parametric avatar. Application B has the advantage of accepting a large number of parameters (other than simple skin color or hair color, or the simple existence of a beard), so that the parametric avatar created remains faithful to the morphology of the user.

As an example, an application B for creating a generic avatar with a parametric approach may be the “Make Human Project”: http://www.makehumancommunity.org/ (open access for the source code), or MB-Lab https://mblab.dev/ (plugin for the “3D Blender” modeler). Such application examples offer the advantage of being flexible in their programming and in particular of accepting a large number of morphological parameters of the user.

In step S3, application B receives the configured parameters for the morphological data of the user (length of limbs, exact shapes of the face, skin and hair colors, etc.) and constructs a parametric avatar in compliance with all the morphological data provided.

The user thus obtains a parametric avatar as realistic as application B allows, by relying on a first dense avatar obtained by means of acquisition device A. This avatar is in particular the measurements of the user, relative or absolute, which is welcome in particular for mixed reality telepresence systems.

Referring now to FIG. 2, the user may then, in step S4, modify his or her realistic parametric avatar as desired. The user may dress it with virtual clothing, create different avatars according to needs and the choice of representation in a metaverse. The user may modify its appearance, erase physical defects, change the eye color, hair color, skin color, or make other changes. Several possible modifications to the realistic avatar may be recorded so that the user then has a set of avatars to choose from depending on the context in the metaverse (e.g. in a business suit for a metaverse with customers, dressed casually with friends, or disguised and physically transformed to celebrate Halloween, etc.). For example:
a first avatar AVAT1 may be suitable for a first application APPLI1, for example virtual videoconferencing in a work interview context,
a second avatar AVAT2 may be suitable for a second application APPLI2, for example online gaming,
a third avatar AVAT3 may be suitable for a third application APPLI3, for example discussion in an informal social network,
etc.

In addition to the physical appearance, a modification of the individual's posture may be provided for, or even a modification to the manner in how the user moves his or her body (for example hand movements, gait, etc.).

Furthermore, advantageously, the current application APPLIi (i=1, 2, or 3) may, while running, automatically modify the user's avatar AVATi. For example, the appearance of the user's avatar may become increasingly realistic during a virtual video conference in a work interview context, if the application detects that the mood of the participants indicates a climate of trust between speakers during the interview. In the context of a gaming application, the appearance of the user's avatar may become more and more “muscular” as the user wins rounds of the game, for example. This step of modifying the avatar according to the execution of the application is illustrated by arrow S5 in FIG. 2.

Referring now to FIG. 3, a device DIS for implementing the above method may comprise a processing circuit comprising for example:
an input interface IN for receiving, for example, image data acquired by one or more cameras A,
a memory MEM for storing the instructions of a computer program of the type introduced above, and possibly storing at least temporarily the acquired image data,
a processor PROC capable of cooperating with the memory MEM to read and execute the instructions of such a program in order to control an application for creating a parametric avatar by providing it with relevant parameters derived from the image data, and
an output OUT to deliver the data of a realistic parametric avatar, in the illustrated example.

Device DIS may be hosted on a server, in order to provide, via a communications network, an avatar version to a remote terminal available to the user. Optionally, the user may choose, online, an avatar version as desired and according to his or her needs. This choice may be received (e.g. “change eye color”, etc.) for example via input interface IN of device DIS.

Alternatively to the use of an output interface, the creation of the avatar may be carried out locally with a simple storage of the avatar data in memory MEM, for example in a terminal available to the user.

The object of the present invention thus allows the creation of customizable parametric avatars based on the user's real appearance. The use of an avatar can be extremely broad, and increasingly corresponds to an essential element of non-verbal communication between remote users. The object of the present invention considerably reduces the time to create the avatar, allows obtaining a parametric avatar which has the user's body measurements (or possibly transformed as desired by the user), and allows creating multiple avatars according to the user's needs/tastes/choices/preferences.

However, in addition to configuring the parameters for the user's physical appearance data, it is also possible to configure the parameters for the user's voice, as well as their expression and manner of speaking. For example, in addition to the image data acquired in step S1, it is possible to have text read by the user and record the user's voice using one or more microphones. Using pitch and formant detection in the user's voice, it is then additionally possible to provide configured data for the user's voice (average pitch frequency, average respective intensities of the formants, and/or others) to an application for creating a parametric sound avatar, in step S2. In step S4, the user may slightly transform his or her voice, for example by making it deeper in pitch frequency, or the current application APPLIi may modify the voice by making it deeper, for example as the user wins rounds of a game. More generally, in addition to transforming the voice, it is possible to have the avatar speak in another language, or to modify/correct its oral expression with words that are more appropriate for a context for example.

More generally, the present invention is not limited to the embodiments described above by way of examples. It extends to other variants.

For example, we described above an artificial intelligence for determining the different parts of the body and configuring their parameters. However, a photogrammetry application, combined with a colorimetry application, may already allow determining the morphological parameters of the user, in sufficient number to provide information to an application for creating a parametric avatar that is capable of generating a realistic avatar, and therefore does so without necessarily calling upon artificial intelligence. Of course, these applications may be programmed to be compatible with the parameters expected by the parametric avatar creation model.

Although the present disclosure has been described with reference to one or more examples, workers skilled in the art will recognize that changes may be made in form and detail without departing from the scope of the disclosure and/or the appended claims.

1. A method for creating an avatar of a user, the method being implemented by a computer device and comprising:
obtaining at least image data of the user and processing said data in order to determine morphological parameters specific to the user; and
applying, to a parametric avatar model, the morphological parameters specific to the user in order to obtain a personalized parametric avatar of the user.

2. The method of claim 1, wherein the obtaining comprises acquiring the image data by a plurality of cameras in order to construct a stereoscopic 3D model of the user.

3. The method according to claim 1, wherein the obtaining comprises acquiring the image data by at least one infrared camera in order to acquire at least image depth data of the user and construct a 3D model of the user.

4. The method according to claim 1, comprising:
determining, based on said image data, at least relative body measurements of the user by photogrammetry, and evaluating morphological parameters characteristic of the user.

5. The method according to claim 4, wherein the image data further comprises data from a test pattern of known dimension, in order to determine absolute measurements of the user.

6. The method according to claim 1, comprising:
determining, by colorimetry and based on said image data, at least a skin color and/or hair color of the user.

7. The method according to claim 1, comprising:
making use of artificial intelligence to identify, based on said image data, different parts of the user's body and to configure parameters for said different parts of the body.

8. The method according to claim 1, wherein an application for creating a parametric avatar is programmed to accept as input parameters at least the following:
shapes and dimensions of elements of the user's face,
colors of at least one of the user's skin or hair,
dimensions of segments of the user's limbs.

9. The method according to claim 1, further comprising:
modifying the personalized parametric avatar of the user, at the user's request.

10. The method according to claim 1, further comprising, during execution of an application in which the user's avatar takes part:
modifying the personalized parametric avatar of the user, upon receiving a command from the application.

11. The method according to claim 1, wherein, in addition to the image data, voice data of the user is acquired in order to accompany a physical appearance of the personalized avatar of the user, with a realistic vocal expression of the user.

12. A non-transitory computer-readable storage medium on which a program is stored, said program comprising instructions for implementing a method for creating an avatar of a user, when said instructions are executed by at least one processor of a processing circuit, wherein the method comprises:
obtaining at least image data of the user and processing said data in order to determine morphological parameters specific to the user; and
applying, to a parametric avatar model, the morphological parameters specific to the user in order to obtain a personalized parametric avatar of the user.

13. A computer device comprising:
a processing circuit configured to implement a method of creating an avatar of a user, the method comprising:
obtaining at least image data of the user and processing said data in order to determine morphological parameters specific to the user; and
applying, to a parametric avatar model, the morphological parameters specific to the user in order to obtain a personalized parametric avatar of the user.
